(19) United States
(12) Patent Application Publication
(10) Pub. No.: US 2014/0076673 A1
(43) Pub. Date: Mar. 20, 2014

(54) COLLECTING DEVICE FOR BRAKE DUST

(71) Applicant: Konstantinos Tsiberidis, Heilbronn (DE)

(72) Inventor: Konstantinos Tsiberidis, Heilbronn (DE)

(73) Assignee: KT Projektentwicklungs-GmbH, Heilbronn (DE)

(21) Appl. No.: 13/992,873

(22) PCT Filed: Dec. 5, 2011
(86) PCT No.: PCT/EP2011/071769

§ 371 Date: Oct. 17, 2013

(30) Foreign Application Priority Data
Dec. 9, 2010 (DE) 102010053879.5

(51) Int. Cl. F16D 65/00; F16D 55/22

(52) U.S. Cl. CPC F16D 65/0031; F16D 55/22
USPC 188/73.1

(57) ABSTRACT

The present invention relates to a brake dust collecting device of a disc brake; the disc brake includes a brake disc, a brake caliper, and at least one brake pad; the at least one brake pad is situated on one side of the brake disc and in a first subregion, overlaps the brake disc in its main axial direction; and the at least one brake pad has an enclosure that at least partially encompasses the at least one brake pad; the present invention also relates to a disc brake and motor vehicle equipped with the collecting device.

### FIELD OF THE INVENTION

The present invention relates to a brake dust collecting device as well as to a disc brake equipped with such a brake dust collecting device and a motor vehicle equipped with such a brake dust collecting device.

### BACKGROUND OF THE INVENTION

A disc brake is a type of brake that is widely used, among other things, in motor vehicles. Essential components of a disc brake include a brake disc, a brake caliper, and brake pads. For the braking procedure, the brake pads are pressed against the brake disc, for example by means of a hydraulic cylinder/brake cylinder; the friction between the brake pad and the brake disc counteracts a movement of the brake disc. In this process, the powerful exertion of force generates abrasion debris that is essentially composed of the material of the brake pad. The fine-grained abrasion debris is partially dispersed with the ambient air and is also referred to as brake dust.

It has been recognized for some time that this brake dust has negative repercussions on the brake apparatus and also on the environment. For example, brake dust collects on components of the motor vehicle, which is undesirable on the one hand for aesthetic reasons and on the other hand, can result in damage to the surfaces of the components. Allowing the brake dust to escape into the environment is also undesirable because the brake dust is partly composed of materials that are hazardous to health.

In order to solve these problems, DE 10 2006 051 972 A1 has disclosed a brake dust collecting device, which is designed to collect the brake dust generated so that it does not come into contact with either other components or the environment. The brake dust collecting device described is situated after the brake caliper and brake pads, viewed in the main rotation direction of the brake disc. In addition to brake dust inlet openings, the device also has air inlet openings that are separate from the brake dust inlet openings and permit the brake disc to be cooled.

It has turned out that the device described above does in fact collect a part of the brake dust, but that another part of the brake dust is able to escape, particularly in the axial direction of the brake disc.

The object of the invention, therefore, is to create a device that is able to reduce the escape of brake dust into the environment in comparison to the known prior art.

### SUMMARY OF THE INVENTION

The brake dust collecting device according to the invention is provided for a disc brake that has a brake disc, a brake caliper, and at least one brake pad. The at least one brake pad in this case is situated on one side of the brake disc and in a first subregion, overlaps the brake disc in the main axial direction of the brake disc. The “main axial direction” should be understood to be a direction along or parallel to the axis around which the brake disc rotates. In the braking procedure, the at least one brake pad is pressed against the brake disc in a direction parallel to the latter's main axial direction, which causes the brake pad and the brake disc to come into contact and thus counteracts the movement of the brake disc. In the brake dust collecting device according to the invention, the at least one brake pad has an enclosure that at least partially encloses the brake pad. In this way, already at its point of origin (the at least one brake pad), brake dust that is generated can be prevented from escaping into the environment. Thus, brake dust that is generated can already be prevented from escaping into the environment at its point of origin (the at least one brake pad).

In a preferred embodiment, the enclosure is an integral component of the brake caliper. Alternatively, the enclosure can be a separate component that is mounted on the brake caliper in movable fashion and can therefore be moved relative to it. In another embodiment of the invention, the enclosure is mounted on the brake pad associated with it.

Preferably, the enclosure has a conduit through which the brake dust can be conveyed away after it has been collected at the brake pad. In a preferred embodiment, the collecting device has one or more chambers into which the brake dust is conveyed, preferably through the conduit. The chamber(s) can contain plates and/or a filter device that help keep the brake dust in the chamber and prevent it from traveling out of the chamber again, for example, due to an air current.

In order to permit the brake pad, despite the presence of the enclosure, to be pressed toward the brake disc in the simplest possible way, the enclosure is provided with openings in a preferred embodiment. In this case, an actuating device can reach through the openings to act on the brake pad and thus move it toward the brake disc and alternatively or additionally, guide elements of the brake pad can be routed out of the enclosure through these openings. Advantageously, the guide elements of the brake pad are guided by and in the enclosure so as to permit the most uniform possible movement of the brake pad relative to the brake disc. The openings are preferably provided for a brake cylinder and/or parts of the brake caliper. In this connection, it is particularly advantageous if the openings have a basic shape that corresponds to or is at least similar to the basic shape of the element guided by them. in this way, only a small gap remains through which brake dust can escape. Alternatively or in addition to the openings, guide rails are provided in which the guide elements of a brake pad are guided.

In order to further reduce the escape of brake dust into the environment, in an advantageous modification of the invention, at least one seal is provided, particularly in the region of the openings, and seals the above-described gap. This at least one seal can advantageously be a rubber seal, a ceramic seal, or a brush seal.

Since part of the brake dust can also settle on the brake disc, in an advantageous modification of the invention, at least one stripper element is provided, which removes at least part of the brake dust from the brake disc and conveys it into the enclosure. It is thus possible to prevent brake dust that has settled on the brake disc outside of the enclosure from detaching from the brake disc and escaping into the environment. The at least one stripper element in this case can be advantageously embodied in the form of a stripper plate and/or a stripper brush. The stripper brush here is in turn advantageously composed essentially of cobalt. The stripper elements can be situated both in the region of the brake caliper and elsewhere, for example in the region of the chamber(s).

In another advantageous modification of the invention, at least one compression spring is situated between the enclosure and the brake caliper and presses the enclosure toward the brake disc. This compression spring also has an advantageous effect on the removal of brake dust from the brake disc and is considered to be particularly advantageous, especially in combination with the stripper elements. Consequently, in a preferred embodiment of the collecting device according to the invention, the enclosure is dimensioned so that on the brake disc side, a small gap remains between the enclosure and the brake disc or the enclosure rests against the brake disc with a slight pressure. In this case, it is likewise possible for the enclosure to rest against the brake disc in only some regions. In particular, the enclosure can rest against the brake disc in the region of the stripper elements, while in other regions, a gap remains or the contact pressure is lower than in the region of the stripper elements.

Because of the heat generated by friction during a braking procedure, it can be advantageous if edges or regions of the enclosure oriented toward the brake disc are composed of a ceramic, a heat-resistant metal, or a heat-resistant plastic or alternatively are coated with a ceramic, a heat-resistant metal, or a heat-resistant plastic.

In an advantageous modification, the collecting device is positioned so that in a second subregion, it overlaps the brake disc in the main axial direction of the brake disc. This permits a compact design and an improved collection of brake dust in the collecting device. In this case, the collecting device is advantageously situated after the brake caliper in a rotation direction.

A disc brake according to the invention has a brake dust collecting device according to the invention and is advantageously embodied with a floating caliper design. A motor vehicle according to the invention is equipped with a brake dust collecting device according to the invention.

### BRIEF DESCRIPTION OF THE DRAWINGS

The invention will be explained by way of example in conjunction with the drawings: in the drawings:

FIG. 1 shows a partial section through a disc brake with one embodiment of a brake dust collecting device according to the invention;

FIG. 2: shows a disc brake with one embodiment of a brake dust collecting device according to the invention, viewed from the side of the brake cylinder;

FIG. 3: shows the disc brake from FIG. 2, viewed from the opposite side;

FIG. 4: shows an enclosure of a brake dust collecting device according to the invention;

FIG. 5; shows a disc brake with one embodiment of a brake dust collecting device according to the invention in a partially sectional view perpendicular to the main axial direction of the brake disc.

### DETAILED DESCRIPTION OF THE PREFERRED EMBODIMENTS

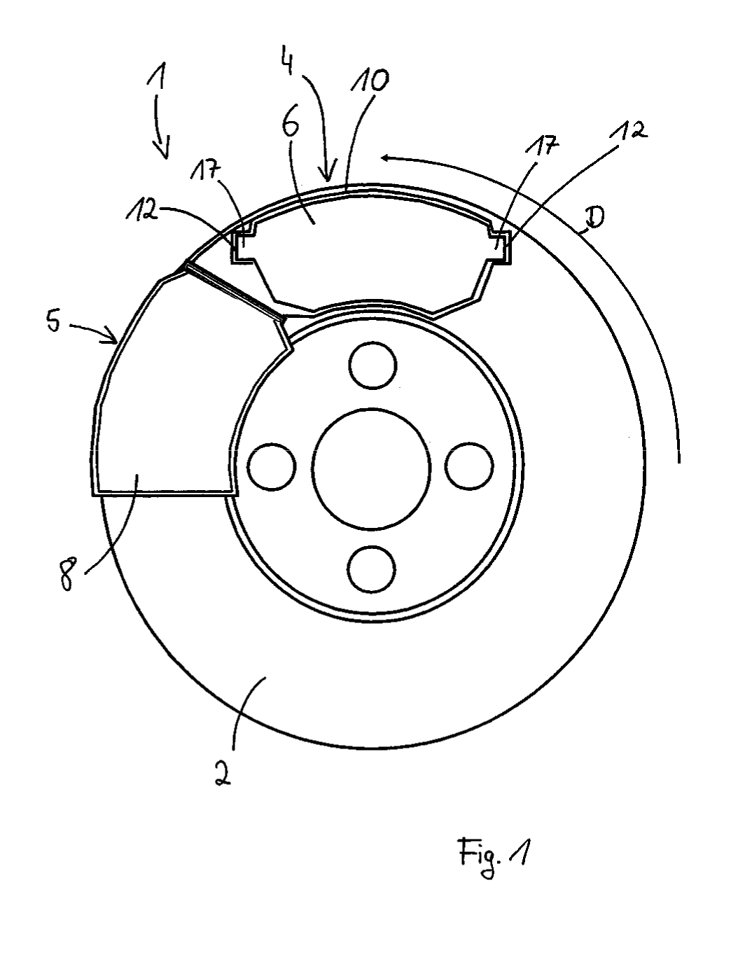

The disc brake 1 shown in FIG. 1 has a brake disc 2, a brake caliper 3, and two brake pads 6; only one of the brake pads 6 is visible. The brake pads 6 overlap the brake disc 2 in a first subregion 4. A brake dust collecting device according to the invention belonging to the disc brake 1 has an enclosure 10 that encompasses the brake pads 6. In FIG. 1, the enclosure is partially “cut away” so that the underlying brake pad 6 and other details are visible.

The brake pad 6 has two guide elements 17 that are guided in openings 12 of the enclosure 10. In one rotation direction D, a chamber 8 is provided, which overlaps the brake disc 2 in a second subregion 5. During the braking procedure, the brake dust can be conveyed into the chamber 8 and can collect therein.

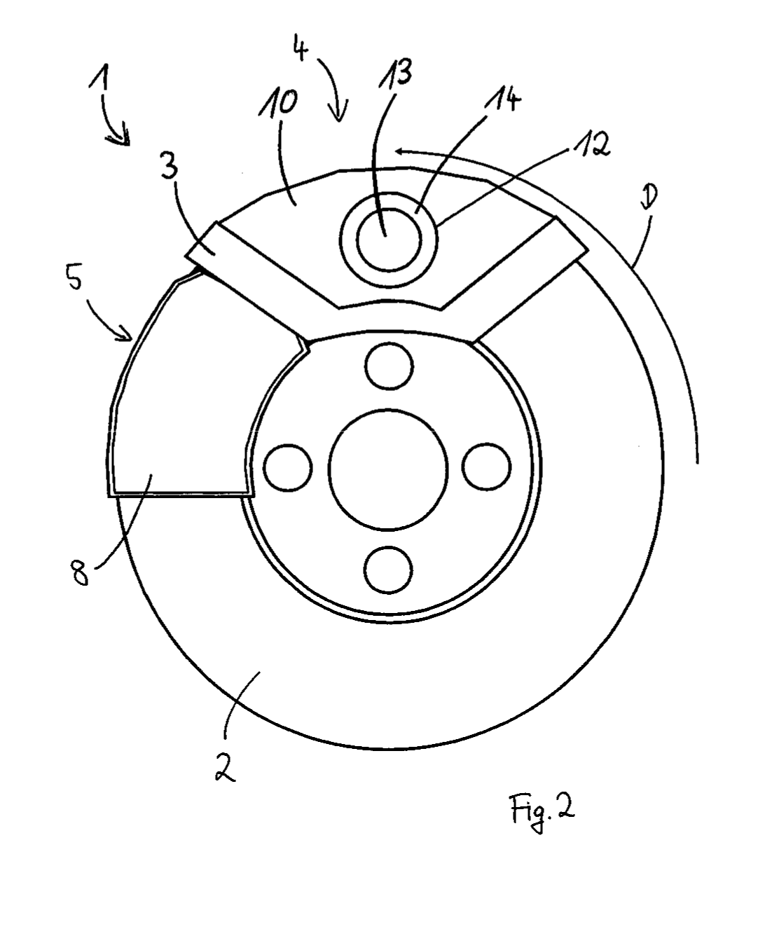

FIG. 2 shows the same view of a disc brake as FIG. 1, but in this case, the enclosure 10 is not cut away. It therefore shows that the enclosure 10 has an opening 12 through which a brake cylinder 13 can act. The (edge) region of the opening 12 that is not covered by the piston of the brake cylinder 13 is sealed by a seal 14 so that generated brake dust cannot escape from the enclosure 10.

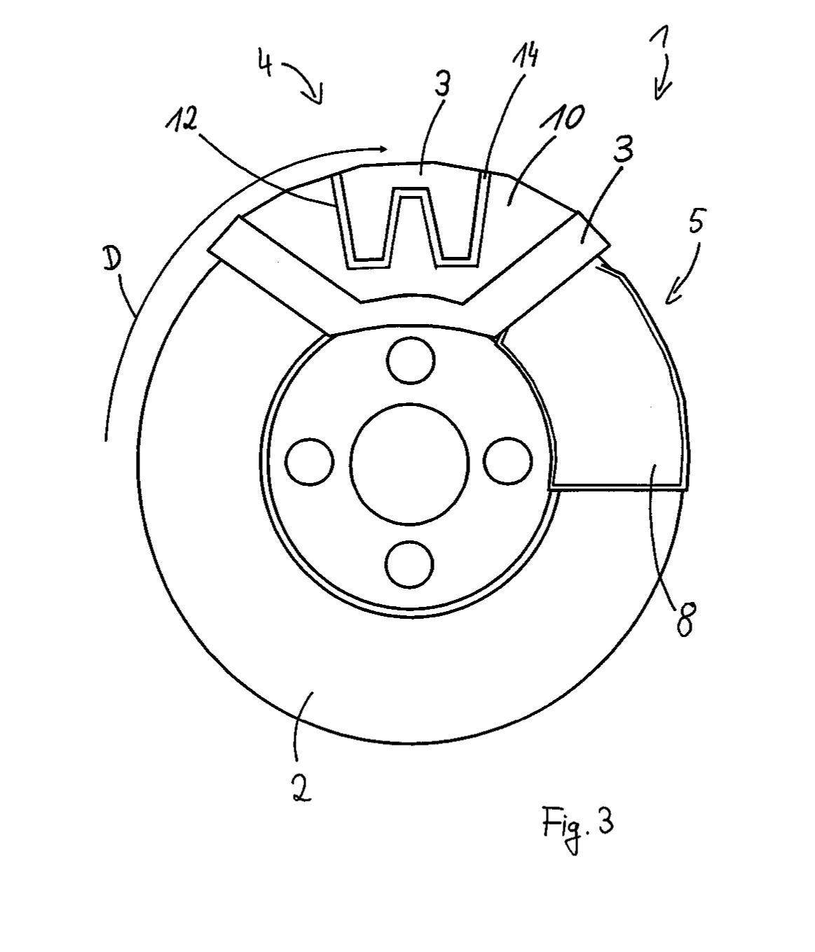

FIG. 3 shows the same embodiment of the brake dust collecting device according to FIG. 2, viewed from the opposite side. On this side, the enclosure 10 of the brake dust collecting device has an opening 12 for parts of the brake caliper 3. Here, too, a seal 14 is provided, which seals the gap between the opening 12 and the brake caliper 3. The disc brake 1 of the embodiment shown here is embodied with a floating caliper design. This means that the brake cylinder 13 exerts pressure during the braking procedure and in so doing, is supported against a part of the brake caliper 3 on the opposite side of the brake disc 2. In this case, the movement of the brake disc 2 is inhibited by respective brake pads 6 on each of the two sides. The brake dust generated as a result is captured by the enclosure 10 and is conveyed by the rotation direction D into the chamber 8 of the collecting device.

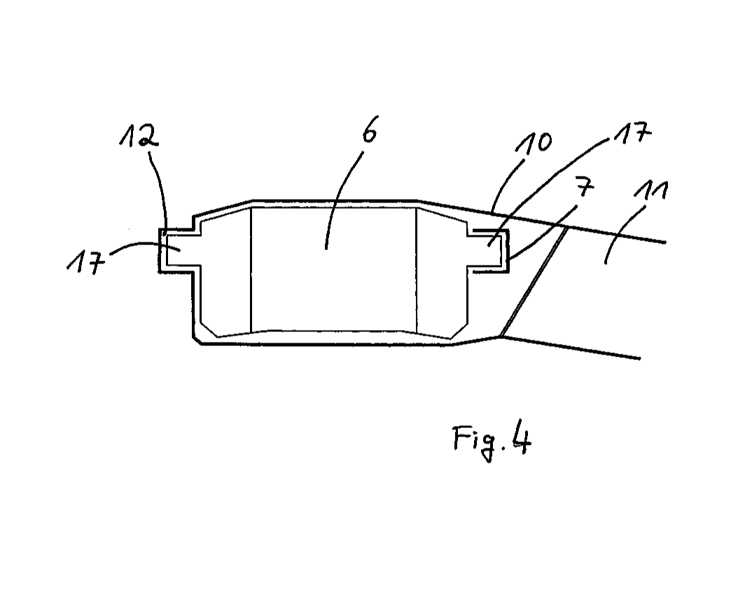

FIG. 4 shows a brake pad 6, with the enclosure 10 encompassing it. The enclosure an opening 12 on the one hand and a guide rail 7 on the other, in which guide elements 17 of the brake pad 6 are guided. The enclosure 10 also has a conduit 11 by means of which brake dust generated at the brake pad is conveyed away from the brake pad 6. In the operational state, the conduit ii leads into a chamber 8 (not shown) of the brake dust collecting device.

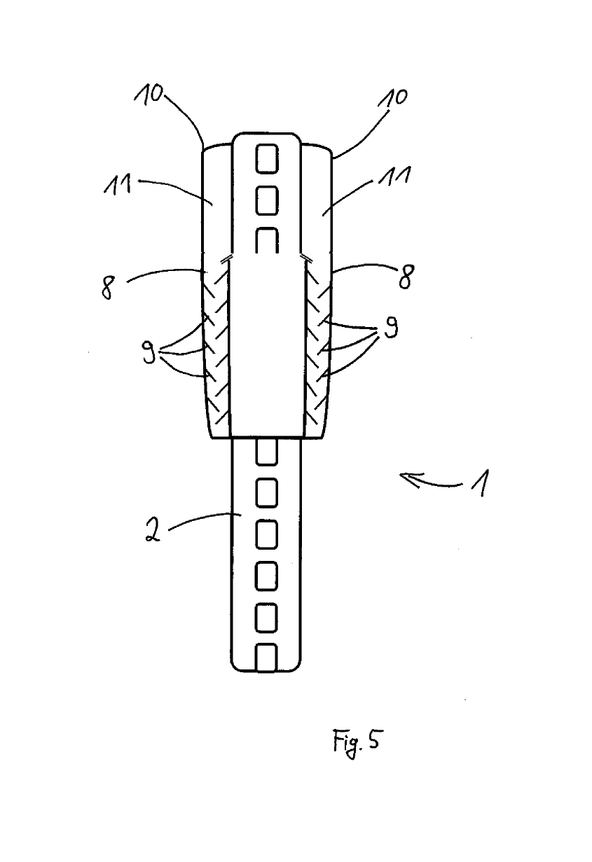

The brake disc 1 shown in FIG. 5 has a brake dust collecting device according to the invention. The collecting device includes two enclosures 10, with one enclosure 10 on each side of a brake disc 2. During an operational braking procedure, generated brake dust is captured by the enclosures 10 and then conveyed into chambers 8 via conduits 11. The chambers 8 each contain respective plates 9. These plates 9 are arranged so that the brake dust can in fact easily enter the chambers 8, but cannot come back out of them again. In this way, the brake dust is kept in the chambers 8. Brake dust in the chambers 8 can, for example, be manually removed from time to time. For this reason, the chambers 8 are detachably connected to the enclosures 10 or the conduits 11.

1. A brake dust collecting device of a disc brake, the disc brake comprising:
a brake disc;
a brake caliper; and
at least one brake pad situated on one side of the brake disc and in a first subregion overlapping the brake disc in its main axial direction: wherein the at least one brake pad has an enclosure that at least partially encompasses the at least one brake pad.

2. The brake dust collecting device according to claim 1, wherein the enclosure is an integral component of the brake caliper.

3. The brake dust collecting, device according to claim 1, wherein the enclosure is a separate component.

4. The brake dust collecting device according to claim 1, wherein the enclosure is able to move relative to the brake caliper.

5. The brake dust collecting device according to claim 1, wherein the enclosure has at least one conduit through which brake dust generated at the brake pad is conveyed away.

6. The brake dust collecting device according to claim 1, wherein the enclosure has at least one opening for an actuating device for moving the brake pad toward the brake disc and/or for guide elements of the brake pad.

7. The brake dust collecting device according to claim 6, wherein the guide elements are guided by guide rails.

8. The brake dust collecting device according to claim 6, wherein the at least one opening is provided for to brake cylinder and/or parts of the brake caliper.

9. The brake dust collecting device according to claim 6, further comprising at least one seal is, which prevents brake dust from escaping through the openings; and the seal is a rubber seal, a ceramic seal, or a brush seal.

10. The brake dust collecting device according to claim 1, wherein the enclosure has at least one stripper element that conveys at least part of the brake dust from the brake disc into the enclosure; and the stripper element is embodied in the form of a stripper plate and/or as a stripper brush composed of cobalt.

11. The brake dust collecting device according to claim 1, further comprising between the enclosure and the brake caliper, at least one compression spring, which presses the enclosure in the direction of the brake disc.

12. The brake dust collecting device according to claim 1, wherein the enclosure is dimensioned so that on the brake disc side, a small gap remains between the enclosure and the brake disc or the enclosure rests with a slight pressure against the brake disc or against one more regions of the brake disc.

13. The brake dust collecting device according to claim 1, wherein edges or regions of the enclosure oriented toward the brake disc are composed of a ceramic, a heat-resistant metal, or a beat-resistant plastic or are coated with a ceramic, a heat resistant metal, or a heat-resistant plastic.

14. The brake dust collecting device according to claim 1, wherein the collecting device overlaps the brake disc in a second subregion in its main axial direction.

15. The brake dust collecting device according to claim 1, wherein the collecting device is situated after the brake caliper in a rotation direction.

16. The brake dust collecting device according to claim 1, wherein on each side of the brake disc, the collecting device has at least one chamber in which brake dust is collected.

17. The brake dust collecting device according to claim 16, further comprising plates and/or a filter device in the at least one chamber.

18. A disc brake, embodied in a floating caliper design, comprising a brake dust collecting device according to claim 1.

19. A motor vehicle comprising a brake dust collecting device according to claim 1.
